(19) United States
(12) Patent Application Publication
(10) Pub. No.: US 2017/0076366 A1
(43) Pub. Date: Mar. 16, 2017

(54) UNIVERSAL TOKENIZATION SYSTEM

(71) Applicant: BANK OF AMERICA CORPORATION, Charlotte, NC (US)

(72) Inventors: Cameron Darnell Wadley, Waxhaw, NC (US); Katherine Dintenfass, Charlotte, NC (US); Damon C. Missouri, Trenton, NJ (US); Alexander C. Wittkowski, Charlotte, NC (US); Alicia C. Jones-McFadden, Fort Mill, SC (US); Angela Fritz Thompson, Matthews, NC (US)

(21) Appl. No.: 14/851,758

(22) Filed: Sep. 11, 2015

(51) Int. Cl. G06Q 40/02; G06Q 50/18

(52) U.S. Cl. CPC G06Q 40/02; G06Q 50/18

(57) ABSTRACT

Disclosed are systems, computer program products, and computer implemented methods for providing a universal tokenization system for customers of an entity. Embodiments of the invention include associating account information of multiple accounts with tokens that may be used to conduct transactions with the associated accounts. Some embodiments of the invention involve establishing electronic communication links with and between customers of the entity and receiving a request from a first customer to combine a first token associated with the first customer with a different, second token associated with a second customer. Some embodiments include combining the account information of the first and second tokens into a third token that may be used by either or both of the first and second customers for conducting transactions or maintaining accounts. In some embodiments, the system includes a notary system for notarizing any documentation necessary for combining accounts of two or more individuals.

### FIELD OF THE INVENTION

This disclosure generally relates to a universal tokenization system.

### BACKGROUND

Tokens, both virtual and physical, serve as convenient and secure devices for organizing, securing, and transferring account information associated with one or more customers of an entity. Certain life events, including marriage, create a desire to combine at least portions of accounts that were previously held under separate ownership.

### SUMMARY OF INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention disclose utilizing a token (e.g., a virtual payment instrument) associated with a payment device (e.g., a personal computer, a laptop, a mobile device, such as a phone, smartphone, tablet, or personal display device, fob, payment wand, or any other like device). The token may be associated in some embodiments directly with the payment device; however, in other embodiments the token may be associated with a digital wallet stored within the payment device.

The token may be utilized instead of using the actual account information (e.g., account number or other account information) of the account with which the token is associated. As such, customers do not utilize the actual account number or other account information to enter into a transaction and instead utilize the tokens to enter into transactions. Moreover, if the token becomes compromised, instead of having to reissue a new account number, the operating entity or administrator may only need to replace the token while the customer account information stays the same.

Methods, systems, and computer program products are described herein that provide for a universal tokenization system. Some embodiments of the invention comprise retrieving customer account information for a first customer and a second customer; creating a first token associated with the first customer, comprising the customer account information associated with the first customer; and creating a second token associated with the second customer, comprising the customer account information associated with the second customer. Additionally, some embodiments of the invention include providing an electronic communication link with a first customer device associated with the first customer and providing an electronic communication link with a second customer device associated with the second customer. Furthermore, some embodiments of the invention comprise receiving, from the first customer device, a request from the first customer device to combine the first token with the second token. Some embodiments of the invention include prompting the second customer device to display the first customer request to the second customer, and receiving, from the second customer device, a confirmation to combine the first token with the second token. Additionally, some embodiments of the invention comprise creating a third token associated with the first and second customers, comprising combined customer account information associated with the first and second customers.

In some embodiments of the invention, the customer account information associated with the second customer comprises account information associated with a second entity. Additionally, some embodiments of the invention include retrieving the customer account information of the second customer from the second entity, and transferring accounts associated with the second customer from the second entity to the first entity.

In some embodiments of the invention, creating the third token associated with the first and second customers further comprises providing an electronic communication link between the first customer, the second customer, and a notary. Additionally, some embodiments of the invention include receiving a notarized document confirming the authorization of the first customer and the second customer, and creating the third token associated with the first and second customers.

Some embodiments of the invention comprise closing accounts associated with the first token, and closing accounts associated with the second token.

Some embodiments of the invention comprise receiving, from the first customer device, an indication that the first customer no longer wishes to combine the account information associated with the first customer with the account information associated with the second customer, and separating the combined customer account information associated with the first and second customers. Additionally, some embodiments of the system include re-associating the customer account information associated with the first customer with the first token, re-associating the customer account information associated with the second customer with the second token, and terminating the third token.

To the accomplishment of the foregoing and related objectives, the embodiments of the present invention comprise the function and features hereinafter described. The following description and the referenced figures set forth a detailed description of the present invention, including certain illustrative examples of the one or more embodiments. The functions and features described herein are indicative, however, of but a few of the various ways in which the principles of the present invention may be implemented and used and, thus, this description is intended to include all such embodiments and their equivalents.

The features, functions, and advantages that have been discussed may be achieved independently in various embodiments of the invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a general process flow for providing universal tokenization, in accordance with an embodiment of the invention;

FIG. 2 is a general process flow for providing universal tokenization using a notary system, in accordance with an embodiment of the invention; and

FIG. 3 is a block diagram of a system environment for providing universal tokenization, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, and the like, and/or may not include all of the devices, components, modules, and the like, discussed in connection with the figures. A combination of these approaches may also be used.

The steps and/or actions of a method or algorithm described in connection with the embodiments disclosed herein may be embodied directly in hardware, in one or more software modules (also referred to herein as computer-readable code portions) executed by a processor or processing device and configured for performing certain functions, or in a combination of the two. A software module may reside in RAM memory, flash memory, ROM memory, EPROM memory, EEPROM memory, registers, a hard disk, a removable disk, a CD-ROM, or any other form of non-transitory storage medium known in the art. An exemplary storage medium may be coupled to the processing device, such that the processing device can read information from, and write information to, the storage medium. In the alternative, the storage medium may be integral to the processing device. Further, in some embodiments, the processing device and the storage medium may reside in an Application Specific Integrated Circuit (ASIC). In the alternative, the processing device and the storage medium may reside as discrete components in a computing device. Additionally, in some embodiments, the events and/or actions of a method or algorithm may reside as one or any combination or set of codes or code portions and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions, code, or code portions on a computer-readable medium. Computer-readable media includes both non-transitory computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

As used herein, an “entity” may be any business, organization, or individual that owns, operates, or is otherwise associated with a token or the accounts associated with a token. Although some embodiments of the invention described herein are generally described as involving an “entity,” other embodiments of the invention may involve business institutions that take the place of or work in conjunction with the entity. In some embodiments of the invention, the entity is a financial institution, or a bank.

The present invention relates to tokenization, which is generally described in the area of financial transactions as utilizing a “token” (e.g., an alias, substitute, surrogate, or other like identifier) as a replacement for sensitive account information, and in particular account numbers. As such, tokens or portions of tokens may be used as a stand in for a customer account number, customer name, pin number, routing information related to the financial institution associated with the account, security code, or other like information relating to the customer account. The one or more tokens may then be utilized as a payment instrument to complete a transaction. The one or more tokens may be associated with one or more payment devices directly or within one or more digital wallets associated with the payment devices. In other embodiments, the tokens may be associated with electronic transactions that are made over the Internet instead of using a physical payment device. Utilizing a token as a payment instrument instead of actual account information, and specifically an account number, improves security, and provides flexibility and convenience in controlling the transactions, controlling accounts used for the transactions, and sharing transactions between various customers.

Tokens may be 16-digit numbers (e.g., like credit, debit, or other like account numbers), may be numbers that are less than 16-digits, or may contain a combination of numbers, symbols, letters, or the like, and be more than, less than, or equal to 16-characters. In some embodiments, the tokens may have to be 16-characters or less in order to be compatible with the standard processing systems between merchants, acquiring financial institutions (e.g., merchant financial institution), card association networks (e.g., card processing companies), issuing financial institutions (e.g., customer financial institution), or the like, which are used to request authorization, and approve or deny transactions entered into between a merchant (e.g., a specific business or individual customer) and a customer. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings, combinations thereof, or the like).

A customer may have one or more digital wallets on the customer's payment device. The digital wallets may be associated specifically with the customer's financial institution, or in other embodiments may be associated with a specific merchant, group of merchants, or other third parties. The customer may associate one or more customer accounts (e.g., from the same institution or from multiple institutions) with the one or more digital wallets. In some embodiments, instead of the digital wallet storing the specific account number associated with the customer account, the digital wallet may store a token or allow access to a token (e.g., provide a link or information that directs a system to a location of a token), in order to represent the specific account number during a transaction. In other embodiments of the invention, the digital wallet may store some or all of the customer account information (e.g., account number, customer name, pin number, or the like), including the customer account number, but presents the one or more tokens instead of the customer account information when entering into a transaction with a merchant. The merchant may be a business, a person that is selling a good or service (hereinafter “product”), or any other institution or individual with which the customer is entering into a transaction.

The digital wallet may be utilized in a number of different ways. For example, the digital wallet may be a device digital wallet, a cloud digital wallet, an e-commerce digital wallet, or another type of digital wallet. In the case of a device digital wallet the tokens are actually stored on the payment device. When the device digital wallet is used in a transaction the token stored on the device is used to enter into the transaction with the merchant. With respect to a cloud digital wallet the device does not store the token, but instead the token is stored in the cloud of the provider of the digital wallet (or another third party). When the customer enters into a transaction with a merchant, transaction information is collected and provided to the owner of the cloud to determine the token, and thus, how the transaction should be processed. In the case of an e-commerce digital wallet, a transaction is entered into over the Internet and not through a point of sale terminal. As was the case with the cloud digital wallet, when entering into a transaction with the merchant over the Internet the transaction information may be captured and transferred to the wallet provider (e.g., in some embodiments this may be the merchant or another third party that stores the token), and the transaction may be processed accordingly.

Specific tokens, in some embodiments, may be tied to a single customer account, but in other embodiments, may be tied to multiple customer accounts, as will be described throughout this application. In some embodiments a single tokens could represent multiple accounts, such that when entering into a transaction the customer may select the token (or digital wallet associated with the token) and select one of the one or more accounts associated with the token in order to allocate the transaction to a specific account. In still other embodiments, after selection of the token by the customer the system may determine the best account associated with the token to use during the transaction (e.g., most cash back, most rewards points, best discount, or the like). In addition, the tokens may be associated with a specific digital wallet or multiple digital wallets as desired by the institutions or customers.

Moreover, the customer accounts associated with the tokens may include trusts, investment vehicles, savings accounts, customer debts, and other non-traditional transaction-based accounts and other investment and asset management accounts.

Thus, systems, methods, and computer program products are described herein that provide for a universal tokenization system.

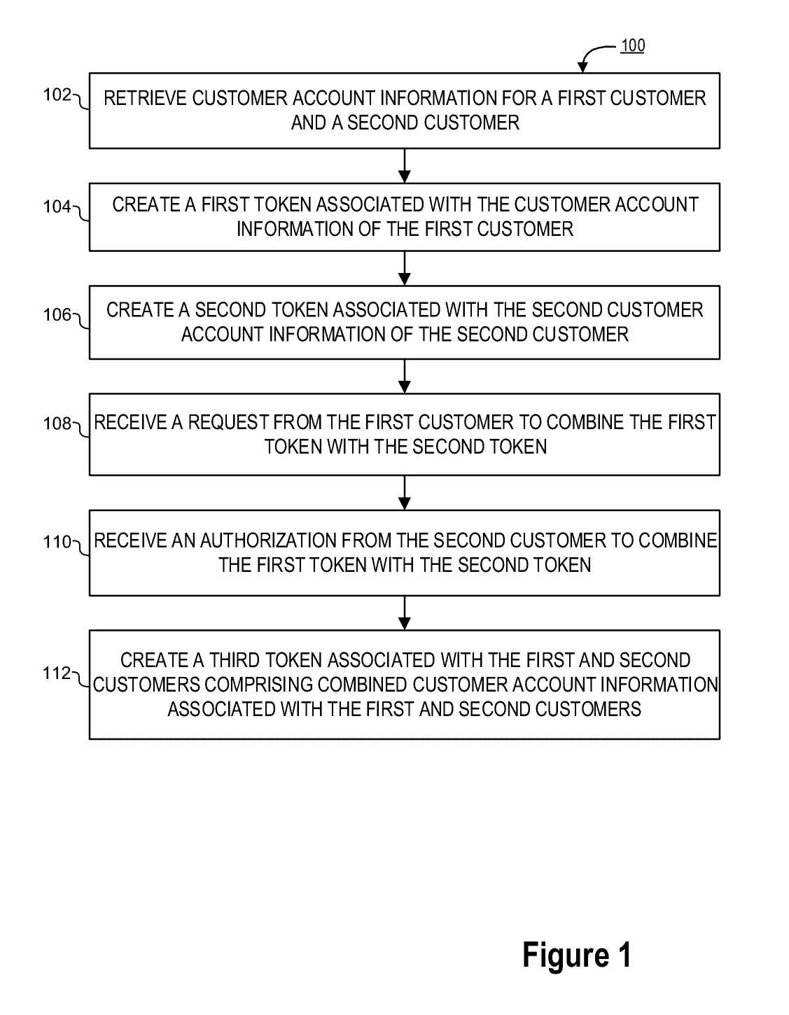

FIG. 1 displays a general process flow 100 for an entity to provide a universal tokenization system, in accordance to embodiments of the invention. The process 100 includes the block 102 of retrieving customer account information for a first customer and a second customer. Customer account information may be any financial account information, credit card information, investment vehicle information, real estate asset information, and the like. Examples of customer account information include account numbers, customer names, pin numbers, routing information related to the entity associated with an account, security codes, and other information related to one or more accounts associated with a customer. The system may store the customer information for the first and second customers in one or more databases associated with the entity. The customer information associated with the first customer may be stored separately from the customer information associated with the second customer.

The process 100 may further include block 104, wherein the system creates a first token associated with the customer account information of the first customer. As mentioned before, the first token may be an alias, substitute, surrogate, or other like identifier of the one or more accounts associated with the first customer. The first token may comprise the customer account information of the first customer, and may be configured to make or receive payments from one or more of the accounts associated with the first customer. In some embodiments, the first token may be associated with one or more digital wallets associated with the accounts of the first customer, such that the digital wallets may conduct transactions with accounts of the first customer, and the first token may serve as an authorization or verification tool for such transactions.

In some embodiments, the first token is associated with every account of the first customer. In some embodiments, the first token is associated only with accounts of the first customer that are managed by the entity. In some embodiments, the first token is associated with one or more accounts of the first customer that are managed by the entity as well as one or more accounts of the first customer that are managed by at least one other entity. For example, the first customer may have a checking account at the entity as well as a credit card with a different financial institution. The system may still associate both the checking account and the credit card with the token by linking the checking account information and the credit card information with the first token. The first customer may then be able to conduct transactions with either (or both) of the checking account and the credit card through the first token. For purchases, the purchase amounts would still be withdrawn or debited from the appropriate account at the appropriate entity, but the first customer may only need to use the first token as the payment vehicle for the transaction.

Additionally, the process 100 may include block 106, wherein the system creates a second token associated with the second customer account information of the second customer. As mentioned before, the second token may be an alias, substitute, surrogate, or other like identifier of the one or more accounts associated with the second customer. The second token may comprise the customer account information of the second customer, and may be configured to make or receive payments from one or more of the accounts associated with the second customer. In some embodiments, the second token may be associated with one or more digital wallets associated with the accounts of the second customer, such that the digital wallets may conduct transactions with accounts of the second customer, and the second token may serve as an authorization or verification tool for such transactions.

In some embodiments, the second token is associated with every account of the second customer. In some embodiments, the second token is associated only with accounts of the second customer that are managed by the entity. In some embodiments, the second token is associated with one or more accounts of the second customer that are managed by the entity as well as one or more accounts of the second customer that are managed by at least one other entity. For example, the second customer may have a checking account at the entity as well as a credit card with a different financial institution. The system may still associate both the checking account and the credit card with the token by linking the checking account information and the credit card information with the second token. The second customer may then be able to conduct transactions with either (or both) of the checking account and the credit card through the second token. For purchases, the purchase amounts would still be withdrawn or debited from the appropriate account at the appropriate entity, but the second customer may only need to use the second token as the payment vehicle for the transaction.

In some embodiments, the process 100 may further include block 108, wherein the system receives a request from the first customer to combine the first token with the second token. In some embodiments, the system provides an electronic communication link to a first customer device of the first customer, and the system may receive the request to combine the first token with the second token through the first customer device. Additionally, the system may receive the request from the second customer via an electronic communication link with a second customer device associated with the second customer. As used herein, a “customer device” is an electronic device that may communicate other network system via the network, and includes input and output mechanisms for such communication. For example, a customer device may be a mobile device, a computer, a tablet, a smart watch or other wearable, and the like. In some embodiments, the output mechanism of the customer device comprises a graphical user interface (GUI) for displaying information to the customer. Likewise, in some embodiments, the input mechanism of the customer device may comprise a touchscreen, a keypad, a mouse, or other input device capable of selecting or entering information into the customer device such that the customer device may transmit the input information to other systems in the system environment via the network.

In some embodiments, the electronic communication link is a secure connection channel between the entity system and the customer device that provides additional data security to the data and information communicated between the customer device and the system. In such embodiments, the electronic communication link may separate data communicate between the entity system and the customer device as part of the process 100 from normal data communication for regular transactions or general communication. Securing the communication data associated with account organization may be important to customers of the entity and therefore may require such enhanced security measures.

Furthermore, in some embodiments of the invention, the process 100 includes block 110, wherein the system receives authorization from the second customer to combine the first token with the second token. In some embodiments, the system receives authorization from the second customer via an electronic communication link provided by the system to a second customer device of the second customer. The electronic communication link may be a secure connection channel between the entity system and the customer device that provides additional data security to the data and information communicated between the customer device and the system. In such embodiments, the electronic communication link may separate data communicate between the entity system and the customer device as part of the process 100 from normal data communication for regular transactions or general communication. Securing the communication data associated with account organization may be important to customers of the entity and therefore may require such enhanced security measures.

In some embodiments, the system may prompt the second customer device to display the first customer's request to combine the first and second token to the second customer. In some embodiments, such a display may include selectable indicia for the second customer to indicate whether the second customer authorizes the combination of the first and second tokens or not. In some embodiments, the system may simply receive a response from the second customer, via the second customer device, indicating whether the second customer authorizes a combination the first and second tokens.

In some embodiments, the system may receive a request or indication from the second customer, via the second customer device, indicating a desired customization of the combination of the first and second tokens. For example, the second customer may not want to combine ownership of every account owned by the second customer with the accounts owned by the first customer. The second customer may therefore input a request into the second customer device indicating a modified organization of ownership and/or access to at least some accounts of the first and second tokens. The system may receive this request and present the first customer with the modified combination request for authorization. As such, the system may provide a means for negotiating and modifying the combination of ownership and/or access to accounts of two or more tokens.

In some embodiments, the process 100 includes block 112, wherein the system creates a third token associated with the first and second customers comprising combined customer account information associated with the first and second customers. In some embodiments, the third token aggregates the account information associated with each of the first and second tokens and associates the total account information with the third token. In some embodiments, the third token may be multiple physical tokens, multiple virtual tokens, a token associated with multiple customer devices or mobile wallets, and the like. Therefore, both the first customer and the second customer may be able to use the third token to conduct transactions using each of the accounts associated with the third token.

In some embodiments, the system may restructure one or more of the accounts associated with the third token to grant access to both the first and second customer. For example, the first customer may have previously owned a first account outright and had sole access to the account, but after combining the first and second tokens into the third token, the system may edit the accessibility restrictions of the first account to grant the second customer access to the first account. In some embodiments, the system may restructure one or more of the accounts associated with the third token to grant ownership to both the first and second customer. For example, the second customer may have previously had sole ownership of a second account, but after combining the first and second tokens into the third token, the system may edit the ownership of the second account to grant ownership to both the first and second customer.

In some embodiments, the system may terminate, cancel, or otherwise close the functionality of the first and or second tokens upon the creation of the third token. In such embodiments, the first and second token would no longer be useable by the first and second customers for transactions. However, in some embodiments the system may continue to allow functionality the first and/or second token for at least one account associated with the first or second token. For example, the system may not combine all accounts associated with the second token into the third token, and therefore the system may continue to maintain the second token at least for transactions associated with the accounts that were not combined into the third token.

In some embodiments, after the system has combined the first and second tokens into a third token, the system may receive a request from the first and/or second customer to disassociate the accounts associated with the third token. In such embodiments, the system may terminate, cancel, or otherwise close the functionality of the third token and re-open the functionality of the first and second tokens. For example, the first customer may decide to no longer permit the second customer to have access to the accounts of the first customer. The first customer may send a request to the system, via the first customer device, for terminating the third token. The system may then re-associate the accounts with their respective original tokens (the first token and the second token). In other embodiments, the request to terminate may further request a new configuration of the separated tokens. For example, the first customer may desire to alter some of the account ownership from the original configurations of the first and second tokens. As such, the system may create a fourth token for the first customer and fifth token for the second customer, and configure the account information, access, and ownership of the accounts previously associated with the third token into the requested configurations for the fourth and fifth tokens. In some embodiments, the system may require authorization of a non-editing customer to take any action that changes the configuration of the third token.

In some embodiments, the system grants different authorization levels for one customer, relative to the other customer for each asset and/or account associated with the third token. In some embodiments, the system may create a separate token for one or more customers associated with the third token, such that the separate token has limited or specialized rights to the accounts and assets associated with the third token. For example, a first and second customer may combine their tokens into the combined third token, but then the system generates a fourth token for a child of the first and/or second customers that allows the child to access a single checking account associated with the third token, up to a certain withdrawal limit. In some embodiments, the extra token may grant an individual viewing rights of one or more accounts or assets of a customer, but not grant any access rights.

In some embodiments, the system may provide user interfaces for each customer associated with the universal token system, whereby each user interface comprises displays unique to each customer based on the customer's assets and accounts associated with the token, the customer's access rights to the assets and accounts, and the customer's input as to what kind of information is important for the customer to visualize. By providing different displays to the customers associated with a single token, the system may allow each customer to view and manage the accounts associated with the single token in a specialized and individualized manner.

While many of the examples used herein comprise two customers combining two tokens, it should be noted that any number of customers may combine any number of their respective tokens into a single token through this system. For example, a first customer may combine a single token with a second customer's single token, and with a third customer's two tokens. By combining more than two tokens between more than two individuals, the system may allow for groups of people, businesses, and families to easily and efficiently combine accounts and assets of the individuals into a single token usable by the entire group.

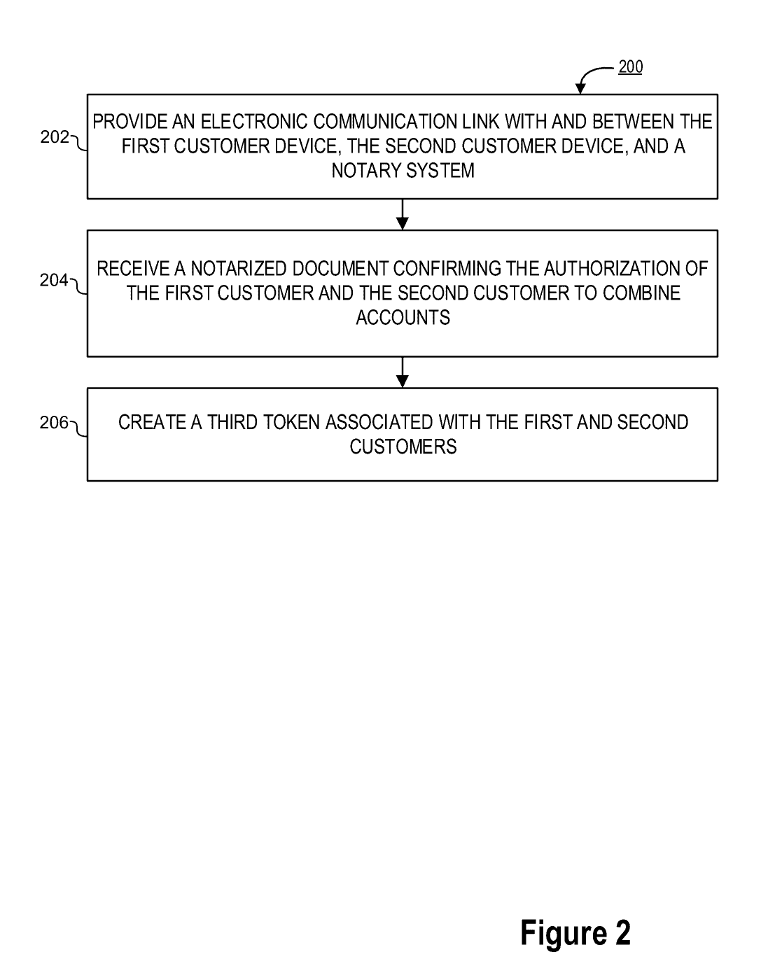

Turning now to FIG. 2, a general process flow 200 is provided for providing a universal tokenization system that includes authorization of a transfer of accounts via a notary, according to some embodiments of the invention. Generally, the process 200 describes embodiments of the invention where a notary is required or desired for reconfiguring accounts, adding new owners to accounts, granting account access to new customers, removing ownership or access rights to accounts, combining tokens, and the like.

The process 200 may include bock 202, wherein the system provides an electronic communication link with and between the first customer device, the second customer device, and a notary system. In some embodiments, the established electronic communication link may be multiple electronic communication links between the entity system, the first customer device, the second customer device, and/or the notary system. In some embodiments, the electronic communication link is a secure connection channel between the entity system and the customer device that provides additional data security to the data and information communicated between the customer device and the system. In such embodiments, the electronic communication link may separate data communicate between the entity system and the customer device as part of the process 200 from normal data communication for regular transactions or general communication. Securing the communication data associated with account organization and notary services may be important to customers of the entity and notaries, and therefore may require such enhanced security measures.

As used herein, a “notary system” may be any physical, virtual, or other system that allows customers to have one or more documents notarized by a Notary Public. In some embodiments, the notary system may be associated with an eNotary, or an individual that is a Notary Public that is authorized to notarize documents electronically. In some embodiments, the Notary Public may notarize documents with digital certificates using cryptography and public key infrastructure. In some embodiments, the notary system may require the communication link to be a video conference, telephone conference, or other communication channel that allows a Notary Public to identify a customer as the individual signing a document. As such, any form of communication channel may be established by the system to accommodate the legal or practical requirements of the notary system.

In some embodiments, the system may prompt the first and/or second customer to communicate with the notary system to notarize one or more documents associated with combining the first and second tokens and/or establishing the third token. The system may require notarization by customers before the system can change the ownership and access restrictions of accounts held by the entity and/or other entities. For example, the first customer may have a first account associated with the first token. When the first and second customer agree to combine the first and second tokens into the third token, the system may provide a physical or electronic document for the first and second customers to sign and have notarized. The system may therefore provide the electronic communication link with the notary system and prompt the first and second customer devices to instruct the first and second customers to have the electronic document notarized via the notary system. The signatures of the first and second customer may be electronic or physical.

In some embodiments, the process 200 includes block 204, wherein the system receives a notarized document confirming the authorization of the first customer and the second customer to combine accounts. In some embodiments, the system may receive the notarized documents directly from the notary system. In some embodiments, the notary system is a component of the entity system, and therefore the system may not need to request or receive the notarized documents. In some embodiments, the notary system may send the notarized document to the first and/or second customer, and the entity system may ultimately receive the notarized documents from the first and/or second customers.

In some embodiments, the system may perform verification tests on the notarized documents to ensure compliance with any applicable laws or policies of the entity. In some embodiments, the system may receive an images of the notarized documents. In such embodiments, the system may retrieve information from the images of the notarized documents using optical character recognition (OCR) to lift typed, handwritten, or printed text from the image and converting the text into machine-encoded text. The system may also identify seals, digital masks, and other security measures applied to the notarized document, so that the system can verify the authenticity and security of the notarized document.

While FIG. 2 and process 200 describe the use of a notary system, any other verification, authentication, and/or legal systems may be used by the system to authorize the combination and/or transfer of accounts and assets of a customer. For example, the system may interact with a Power of Attorney system that grants one customer a Power of Attorney for the other customer(s) for one or more accounts of the other customer(s). As there may be different types and powers for different of Power of Attorney agreements, the system may provide multiple options to the customers for creating a Power of Attorney for one or more of the customers. In some embodiments, the system may interact with a legal system to provide other legal documents and/or services to the customers associate with combining or transferring accounts and assets under the universal tokenization system. For example, the system may communicate with a legal system to retrieve a deed for a real estate asset of the first customer, and the system may provide that the deed or a document based on the deed to both the first and second customers to allow the customers to appropriately restructure the ownership of the real estate asset under both customers. In some embodiments, the system may provide a list of available or necessary documents that the customers may need to execute to authorize the entity to associate the third token with assets that originally belonged solely to the first and second customers, individually.

Additionally, in some embodiments, the process 200 may include block 206, wherein the system creates a third token associated with the first and second customers. In some embodiments, the system only creates the third token upon verification of at least one notarized document. In some embodiments, the system may have received notarized documents for changing the account ownership and/or access information for less that all accounts associated with the third token. In such embodiments, the system may prompt the first and/or second customer devices to display a request for notarization of one or more documents related to these accounts before creating the third token, or before granting full access to these accounts through the third token.

In some embodiments, the third token aggregates the account information associated with each of the first and second tokens and associates the total account information with the third token. In some embodiments, the third token may be multiple physical tokens, multiple virtual tokens, a token associated with multiple customer devices or mobile wallets, and the like. Therefore, both the first customer and the second customer may be able to use the third token to conduct transactions using each of the accounts associated with the third token.

In some embodiments, the system may restructure one or more of the accounts associated with the third token to grant access to both the first and second customer. For example, the first customer may have previously owned a first account outright and had sole access to the account, but after combining the first and second tokens into the third token, the system may edit the accessibility restrictions of the first account to grant the second customer access to the first account. In some embodiments, the system may restructure one or more of the accounts associated with the third token to grant ownership to both the first and second customer. For example, the second customer may have previously had sole ownership of a second account, but after combining the first and second tokens into the third token, the system may edit the ownership of the second account to grant ownership to both the first and second customer.

In some embodiments, the system may terminate, cancel, or otherwise close the functionality of the first and or second tokens upon the creation of the third token. In such embodiments, the first and second token would no longer be useable by the first and second customers for transactions. However, in some embodiments the system may continue to allow functionality the first and/or second token for at least one account associated with the first or second token. For example, the system may not combine all accounts associated with the second token into the third token, and therefore the system may continue to maintain the second token at least for transactions associated with the accounts that were not combined into the third token.

In some embodiments, after the system has combined the first and second tokens into a third token, the system may receive a request from the first and/or second customer to disassociate the accounts associated with the third token. In such embodiments, the system may terminate, cancel, or otherwise close the functionality of the third token and re-open the functionality of the first and second tokens. For example, the first customer may decide to no longer permit the second customer to have access to the accounts of the first customer. The first customer may send a request to the system, via the first customer device, for terminating the third token. The system may then re-associate the accounts with their respective original tokens (the first token and the second token). In other embodiments, the request to terminate may further request a new configuration of the separated tokens. For example, the first customer may desire to alter some of the account ownership from the original configurations of the first and second tokens. As such, the system may create a fourth token for the first customer and fifth token for the second customer, and configure the account information, access, and ownership of the accounts previously associated with the third token into the requested configurations for the fourth and fifth tokens. In some embodiments, the system may require authorization of a non-editing customer to take any action that changes the configuration of the third token.

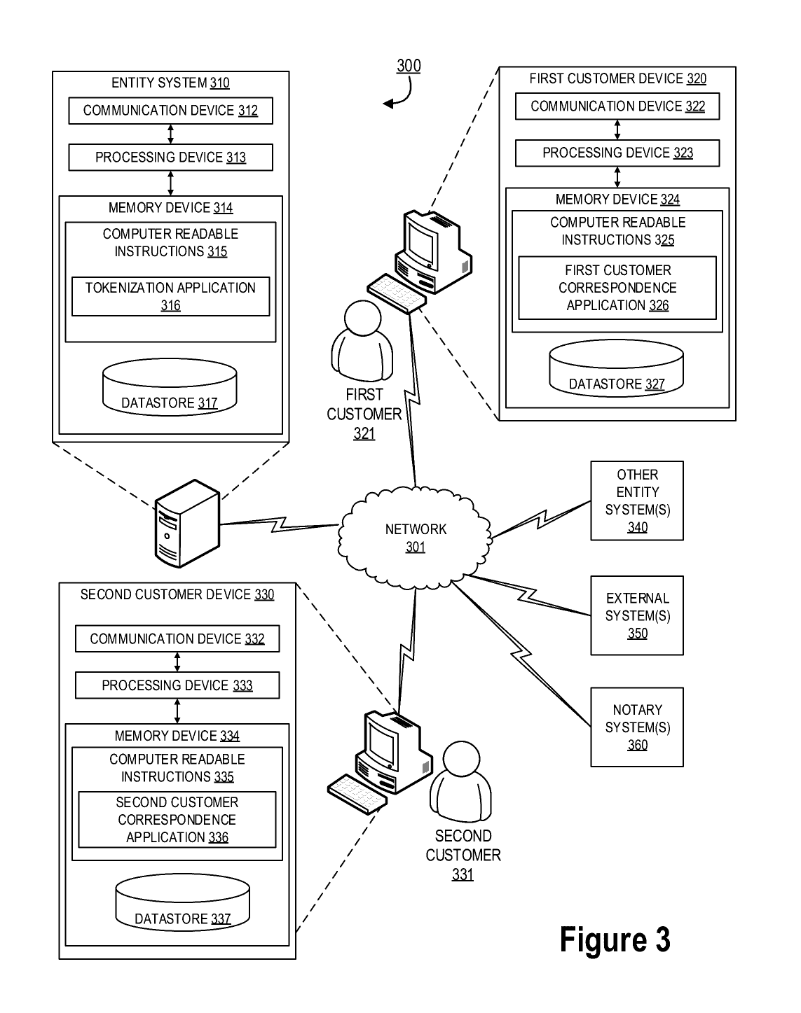

Referring now to FIG. 3, a block diagram of a system environment 300 for universal tokenization is provided, which includes an entity system 310, a first customer system 320 associated with a first customer 321, a second customer system 330 associated with a second customer 331, one or more third party systems 340, one or more external systems 350, a notary system 360, and a network 301.

A “system environment,” as used herein, may refer to any information technology platform of an enterprise (e.g., a national or multi-national corporation), and may include a multitude of servers, machines, mainframes, personal computers, network devices, front and back end systems, database systems, and/or the like.

An “entity,” as used herein, refers to any business or non-business units, including financial institutions, companies that produce and/or provide goods and/or services, companies that sell, offer for sale, distribute, trade, and/or otherwise deal in goods and/or services, government sponsored sectors, or government funded institutes, projects, services, and so on. A “financial institution” may refer to any organization in the business of moving, investing or lending money, dealing in financial instruments, or providing financial services. For example, a financial institute may be a commercial bank, federal and state savings bank, savings and loan association, credit union, an investment company, an insurance company, or the like.

In the system environment 300 shown in FIG. 3, the entity system 310 includes a communication device 312, at least one processing device 313, and at least one memory device 314. The memory device 314 includes computer readable instructions 315 including a tokenization application 316, and a datastore 317. The processing device 313 is operatively coupled to the memory device 314 and configured to execute the tokenization application 316 embedded in the computer readable instructions 315. The datastore 317 may contain account and asset data, social media data, search history data, and transaction data associated with one or more customers of the entity.

The first customer device 320 can be a personal computer, electronic notebook, mobile device, or any computing device that has networking capability and is in communication with the entity system 310 through the network 301. The first customer device 320 is associated with a first customer 321, such that the first customer 321 may receive outputs from, and provide inputs into, the first customer device 320. In some embodiments, the customer device 320 includes a communication device 322, at least one processing device 323, and at least one memory device 324. The memory device 324 includes computer readable instructions 325 including a first customer correspondence application 326, and a datastore 327. The first customer device 320 is operated and managed by the first customer 321.

The second customer device 330 can be a personal computer, electronic notebook, mobile device, or any computing device that has networking capability and is in communication with the entity system 310 through the network 301. The second customer device 330 is associated with a second customer 331, such that the second customer 331 may receive outputs from, and provide inputs into, the second customer device 330. In some embodiments, the customer device 330 includes a communication device 332, at least one processing device 333, and at least one memory device 334. The memory device 334 includes computer readable instructions 335 including a second customer correspondence application 336, and a datastore 337. The second customer device 330 is operated and managed by the second customer 331.

The other entity systems 340 are systems owned and/or operated by entities other than the entity that owns or controls the entity system 310. These other entity systems b 340 may include communication devices, processing devices, datastores, and the like with similar information to the entity system 310, and such information may be transmitted to the entity system 310, the first customer device 320, the second customer device 330, the external systems 350, and/or the notary systems via the network 301. In some embodiments, the other entity system 340 comprises a financial institution associated with one or more accounts owned or managed by the first customer 321 and/or the second customer 331.

The external systems 350 may comprise any other systems accessible by the entity system 310, the first customer device 320, the second customer system 330, and/or the third party systems 340. In some embodiments, the external systems comprise social media systems, investment vehicle systems, real estate management systems, and the like.

The notary systems 360 may comprise one or more notary devices associated with a Notary Public, the one or more notary devices comprising input and output mechanisms that may communicate with the other systems and devices of the system environment 300 via the network 301. In some embodiments, the notary systems 360 comprise encryption, digital certification, and other security and validation components for certifying documents. In some embodiments, the notary system 360 may comprise a video communication device that allows a Notary Public to view and communicate with users, devices, and systems of the system environment 300.

The processing devices 313, 323, and 333 are operatively coupled to the communication devices 312, 322, and 332 and the memory devices 314, 324, and 334. The processing devices 313, 323, and 333 use the communication devices 312, 322, and 332 to communicate with the network 301 and other devices on the network 301, such as, but not limited to, the entity system 310, the first customer device 320, the second customer device 330, the other entity systems 340, the external systems 350, and/or other systems. As such, the communication devices 312, 322, and 332 generally comprise a modem, server, or other device for communicating with other devices on the network 301 and/or a keypad, keyboard, touch-screen, touchpad, display, microphone, mouse, joystick, other pointer device, button, soft key, and/or other input and/or output device(s) for communicating with the first customer 321 and the second customer 331.

In some embodiments, the memory devices 314, 324, and 334 include volatile memory, such as RAM having a cache area for the temporary storage of information. The memory devices 314, 324, and 334 may also include non-volatile memory that may be embedded and/or removable. The non-volatile memory may additionally or alternatively include an Electrically Erasable Programmable Read-Only Memory (EEPROM), flash memory, and/or the like. The memory devices 314, 324, and 334 may store any information and data that are used and administrated by the entity system 310 to implement the functions thereof.

The entity system 310, the first customer device 320, the second customer device 330, the other entity systems 340, and the external systems 350 are each operatively connected to the network 301 and in communication with one another there through. The network 301 can include various networking interfaces, such as a local area network (LAN), a wide area network (WAN), a global area network (GAN), such as Internet, or a hybrid thereof. The network 301 may be secure or unsecure and may also include wireless and/or wireline and/or optical interconnection technology. Each of the entity system 310, the first customer device 320, the second customer device 330, the other entity systems 340, and the external systems 350, may all be similar or the same devices as described above with respect to the entity system 310.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise. In this regard, the term “processor” and “processing device” are terms that are intended to be used interchangeably herein and features and functionality assigned to a processor or processing device of one embodiment are intended to be applicable to or utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| Docket Number | U.S. patent application Ser. No. | Title | Filed On |
|---|---|---|---|
| 6810US1.014033.2511 | | SYSTEM FOR | Concurrently |
| | | RESTRUCTURING BASED ON | Herewith |
| | | PREDICTIVE ANALYSIS | |
| 6812US1.014033.2513 | | SYSTEM FOR MODELING | Concurrently |
| | | AND IMPLEMENTING EVENT- | Herewith |
| | | RESPONSIVE RESOURCE | |
| | | ALLOCATION STRUCTURES | |
| 6813US1.014033.2514 | | SYSTEM FOR SIMULATION | Concurrently |
| | | AND IMPLEMENTATION OF | Herewith |
| | | DYNAMIC STATE- | |
| | | DEPENDENT RESOURCE | |
| | | RECONFIGURATION | |
| 6815US1.014033.2515 | | SYSTEM FOR DYNAMIC | Concurrently |
| | | VISUALIZATION OF | Herewith |
| | | INDIVIDUALIZED | |
| | | CONSUMPTION ACROSS | |
| | | SHARED RESOURCE | |
| | | ALLOCATION STRUCTURE | |
| 6817US1.014033.2516 | | SYSTEM FOR ANALYZING | Concurrently |
| | | PRE-EVENT AND POST- | Herewith |
| | | EVENT INDIVIDUAL | |
| | | ACCOUNTS AND | |
| | | TRANSFORMING THE | |
| | | ACCOUNTS | |
| 6818US1.014033.2517 | | SYSTEM FOR OPENING AND | Concurrently |
| | | CONSOLIDATING ACCOUNTS | Herewith |
| | | BASED ON AN EVENT | |
| | | ASSOCIATED WITH THE | |
| | | ACCOUNT HOLDER | |

What is claimed is:

1. A system for universal tokenization, said system operated by a first entity and comprising:
one or more memory devices having computer readable program code stored thereon; and
one or more processing device operatively coupled to the one or more memory devices, wherein the one or more processing devices are configured to execute the computer readable program code to:
retrieve customer account information for a first customer and a second customer;
create a first token associated with the first customer, comprising the customer account information associated with the first customer;
create a second token associated with the second customer, comprising the customer account information associated with the second customer;
provide an electronic communication link with a first customer device associated with the first customer;
provide an electronic communication link with a second customer device associated with the second customer;
receive, from the first customer device, a request from the first customer device to combine the first token with the second token;
prompt the second customer device to display the first customer request to the second customer;
receive, from the second customer device, a confirmation to combine the first token with the second token; and
create a third token associated with the first and second customers, comprising combined customer account information associated with the first and second customers.

2. The system of claim 1, wherein the customer account information associated with the second customer comprises account information associated with a second entity.

3. The system of claim 2, wherein the one or more processing devices are further configured to execute the computer readable program code to:
retrieve the customer account information of the second customer from the second entity; and
transfer accounts associated with the second customer from the second entity to the first entity.

4. The system of claim 1, wherein creating the third token associated with the first and second customers comprises configuring the one or more processing devices to execute the computer readable program code to:
provide an electronic communication link between the first customer, the second customer, and a notary;
receive a notarized document confirming the authorization of the first customer and the second customer; and
create the third token associated with the first and second customers.

5. The system of claim 1, wherein the one or more processing devices are further configured to execute the computer readable program code to:
close accounts associated with the first token; and
close accounts associated with the second token.

6. The system of claim 1, wherein the one or more processing devices are further configured to execute the computer readable program code to:
receive, from the first customer device, an indication that the first customer no longer wishes to combine the account information associated with the first customer with the account information associated with the second customer;
separate the combined customer account information associated with the first and second customers;
re-associate the customer account information associated with the first customer with the first token;
re-associating the customer account information associated with the second customer with the second token; and
terminate the third token.

7. A computer program product for universal tokenization, the computer program product operated by a first entity and comprising a non-transitory computer readable medium comprising computer readable instructions, the instructions comprising instructions for:
retrieving customer account information for a first customer and a second customer;
creating a first token associated with the first customer, comprising the customer account information associated with the first customer;
creating a second token associated with the second customer, comprising the customer account information associated with the second customer;
providing an electronic communication link with a first customer device associated with the first customer;
providing an electronic communication link with a second customer device associated with the second customer;
receiving, from the first customer device, a request from the first customer device to combine the first token with the second token;
prompting the second customer device to display the first customer request to the second customer;
receiving, from the second customer device, a confirmation to combine the first token with the second token; and
creating a third token associated with the first and second customers, comprising combined customer account information associated with the first and second customers.

8. The computer program product of claim 7, wherein the customer account information associated with the second customer comprises account information associated with a second entity.

9. The computer program product of claim 8, wherein the computer readable instructions further comprise instructions for:
retrieving the customer account information of the second customer from the second entity; and
transferring accounts associated with the second customer from the second entity to the first entity.

10. The computer program product of claim 7, wherein creating the third token associated with the first and second customers further comprises:
providing an electronic communication link between the first customer, the second customer, and a notary;
receiving a notarized document confirming the authorization of the first customer and the second customer; and
creating the third token associated with the first and second customers.

11. The computer program product of claim 7, wherein the computer readable instructions further comprise instructions for:
closing accounts associated with the first token; and
closing accounts associated with the second token.

12. The computer program product of claim 7, wherein the computer readable instructions further comprise instructions for:
receiving, from the first customer device, an indication that the first customer no longer wishes to combine the account information associated with the first customer with the account information associated with the second customer;
separating the combined customer account information associated with the first and second customers;
re-associating the customer account information associated with the first customer with the first token;
re-associating the customer account information associated with the second customer with the second token; and
terminating the third token.

13. A computer implemented method for universal tokenization, said computer implemented method operated by a first entity and comprising:
retrieving, via a processing device, customer account information for a first customer and a second customer;
creating, via a processing device, a first token associated with the first customer, comprising the customer account information associated with the first customer;
creating, via a processing device, a second token associated with the second customer, comprising the customer account information associated with the second customer;
providing, via a processing device, an electronic communication link with a first customer device associated with the first customer;
providing, via a processing device, an electronic communication link with a second customer device associated with the second customer;
receiving, via a processing device, from the first customer device, a request from the first customer device to combine the first token with the second token;
prompting, via a processing device, the second customer device to display the first customer request to the second customer;
receiving, via a processing device, from the second customer device, a confirmation to combine the first token with the second token; and
creating, via a processing device, a third token associated with the first and second customers, comprising combined customer account information associated with the first and second customers.

14. The computer implemented method of claim 13, wherein the customer account information associated with the second customer comprises account information associated with a second entity.

15. The computer implemented method of claim 14, wherein the computer implemented method further comprises:
retrieving, via a processing device, the customer account information of the second customer from the second entity; and
transferring accounts associated with the second customer from the second entity to the first entity.

16. The computer program product of claim 13, wherein creating the third token associated with the first and second customers further comprises:
providing, via a processing device, an electronic communication link between the first customer, the second customer, and a notary;
receiving, via a processing device, a notarized document confirming the authorization of the first customer and the second customer; and
creating, via a processing device, the third token associated with the first and second customers.

17. The computer program product of claim 13, wherein the computer readable instructions further comprise instructions for:
closing, via a processing device, accounts associated with the first token; and
closing, via a processing device, accounts associated with the second token.

18. The computer program product of claim 13, wherein the computer readable instructions further comprise instructions for:
receiving, via a processing device, from the first customer device, an indication that the first customer no longer wishes to combine the account information associated with the first customer with the account information associated with the second customer;
separating, via a processing device, the combined customer account information associated with the first and second customers;
re-associating, via a processing device, the customer account information associated with the first customer with the first token;
re-associating, via a processing device, the customer account information associated with the second customer with the second token; and
terminating, via a processing device, the third token.
